(19) United States
(12) Patent Application Publication
(10) Pub. No.: US 2017/0282702 A1
(43) Pub. Date: Oct. 5, 2017

(54) HYBRID TRANSMISSION HAVING FIXED GEAR SHIFT STAGE

(71) Applicant: Eui Han KIM, Gwangmyeong-si (KR)

(72) Inventor: Eui Han KIM, Gwangmyeong-si (KR)

(21) Appl. No.: 15/623,770

(22) Filed: Jun. 15, 2017

Related U.S. Application Data
(63) Continuation of application No. PCT/KR2015/013358, filed on Dec. 8, 2015.

(30) Foreign Application Priority Data
Jan. 4, 2015 (KR) 10-2015-0000364
May 4, 2015 (KR) 10-2015-0062401

(51) Int. Cl. B60K 6/445; B60K 6/26; B60K 6/547; B60K 6/387; B60K 6/40; F16H 3/72; B60K 6/365

(52) U.S. Cl. CPC B60K 6/445; F16H 3/724; B60K 6/26; B60K 6/365; B60K 6/387; B60K 6/40; B60K 6/547; B60K 2006/266; B60Y 2200/92; Y10S 903/919; Y10S 903/914; Y10S 903/91; Y10S 903/906

(57) ABSTRACT

The present invention relates to a hybrid transmission using an engine and two electric motors/generators together, wherein a planetary gear device comprising double planet gears, two sun gears and a ring gear, as a power splitter is used, and in addition, to a hybrid transmission in which one or more clutches and/or one or more brakes are combined to select a mechanical shift mode other than a hybrid mode and an electric drive mode.

### TECHNICAL FIELD

The present invention relates to a hybrid transmission that has an engine and electric motor/generator, and specially to a hybrid transmission having a planetary gear device that is composed of dual planet gears, two sun gears, carrier and a ring gear as a splitter.

### BACKGROUND ART

The present invention relates to a hybrid transmission for a hybrid vehicle, having a first motor/generator and a second motor/generator that are connected respectively to the rotational axes of the power splitter either directly or through intervening gear(s). The first motor/generator works mainly as a generator, and the second motor/generator mainly as an assist power source for efficient operation of the hybrid transmission.

Generally, a transmission for a vehicle has 4 to 6 speeds, and recently, a transmission exceeding 10 forward speeds has been developed. This is an effort to improve the fuel efficiency as much as possible by transmitting the power of the engine to the driving wheel efficiently while maintaining the acceleration ability and the gradeability of the vehicle. That is, the vehicle may be driven with low gear at the time of start, rapid acceleration, or at the time of driving on a steep slope, and be driven in high gear in case of driving at constant speed or at low acceleration.

### Technical Problem

The existing hybrid vehicle's power train basically includes an engine, motor/generator for assist power source and electric power generation, a splitter that integrates these power sources to transmit power to the output shaft, or a sub-transmission, a battery for reserving electric power from the generator and supplying electric power to the motor, and a control unit for controlling them integrally. Depending on how these components are combined and connected, the hybrid transmission can be classified into several types. There are advantages and disadvantages depending on the types of transmission. Some transmissions are efficient at medium or low speeds but relatively inefficient at high speeds while others are opposite.

Further, in this configuration, since the engine is connected at a low reduction ratio from the engine to the driving wheel, the output torque is insufficient when rapid acceleration is required or when driving on steep slope, and thus the driving performance is greatly affected. To overcome this problem, a relatively large output motor/generator is used as a second motor/generator to provide the driving power (or torque) required. In this case, due to the limitation of the internal space, the relatively large output motor/generator is minimized in size by combining the reduction gear. However, when traveling at high speed, the second motor/generator is idly rotated at excessively high speed which results the efficiency decrease because of increasing drag loss, and it acts as a limiting factor in driving at higher speeds. Moreover, when driving on a steep road for a long time such as a road in the mountainous region, it may be difficult to keep on driving after the battery is discharged.

### SUMMARY OF THE INVENTION

The present invention has been made in order to solve the above-mentioned problems, and it is an object of the present invention to provide a fixed gear shift stage mode in addition to a hybrid mode, which is capable of securing a sufficient acceleration performance and a gradeability without increasing output and torque capacity of a second motor/generator functioning as an assist power source, and at the same time, it has been made in order to ensure sufficient acceleration performance in EV mode in a low speed range and even at time of vehicle start in which the engine can not be run.

### Technical Solution

The hybrid transmission of the present invention realizes an electric driving mode, a hybrid mode, and a fixed gear shift stage mode by a splitter having a dual planet gear as a core part of this invention and one or more brakes and clutches provided on the rotational shafts of the power splitter, thereby gives sufficient acceleration performance and gradeability without enlarging the output of the power source.

The hybrid transmission of the present invention includes a splitter which consists of two sun gears; dual planet gears having gears integrally provided at their both ends thereof and meshing with the two sun gears; planet gear shafts supporting the dual planet gears; a carrier rotating around the two sun gears and receiving the dual planet gears and the planet gear shafts; a first ring gear meshing with the gears disposed on one side of the dual planet gears.

The first ring gear is connected to a third brake for stopping/releasing rotation of it. The engine, the first motor/generator and the second motor/generator are connected to the two sun gears and the carrier of the power splitter respectively, and the combinations of the connection may be different depending on the engine performance and the target performance of the hybrid vehicle.

Preferably, a carrier of the power splitter is selected as a output shaft, and the engine and the first motor/generator are each connected respectively to one of the two sun gears, and the second motor/generator is connected directly to the output shaft of the power splitter. But the second motor/generator may be connected to the output shaft of the power splitter interposing a reduction gears.

Main feature of this hybrid transmission of the present invention is that a first brake and a second brake are provided on the two shafts of the three input and output rotational elements of the power splitter, that is, among the two sun gears and the carrier, two elements are selected for brakes and a second clutch is provided between two rotational elements for engaging and disengaging them selected from the four rotational elements of the power splitter with a ring gear. In the first embodiment of the present invention, the second clutch is provided between two sun gears. In the second embodiment, the second clutch is installed between the two sun gears as in the first embodiment, or alternatively, the second clutch is provided between the output shaft and the sun gear.

A main clutch or a one-way clutch is also provided as a first clutch between the engine and the engine power input shaft of the power splitter to transmit or to stop to transmit the power of the engine to the power splitter, if necessary.

### Advantageous Effects

The hybrid transmission of the present invention has the plural driving modes such as a hybrid mode, an electric motor driving mode, and a fixed gear shift stage mode. The proper driving mode is activated according to the driving condition. That is, it is realized to drive efficiently in the whole speed range, because the efficiency of fuel economy can be maximized in the city driving, and it is possible to drive the vehicle at high efficiency even at a high speed.

Toyota hybrid cars have increased the output of the second motor/generator, which is a assist power source, in order to improve the driving performance on the steep slope and the acceleration performance. In order to increase the output of the second motor/generator, Toyota introduced a reduction gears on the output shaft of the second motor/generator. But this causes the rotational speed of the second motor/generator becomes extremely high during high speed driving.

But in the present invention, since the fixed gear shift stage mode is enabled, the output and size of the second motor/generator can be kept small without a additional reduction gear. With this transmission, it is possible to avoid a big drag loss due to the high rotating speed of the second motor/generator during driving at high speed.

And by selectively connecting the second motor/generator to the main shaft or the output shaft as required, the maximum acceleration performance can be achieved in the entire speed range of the fixed gear shift stage mode.

Even at high speed, the engine can charge the battery as long as the engine power exceeds the power required for driving. The first motor/generator 30 and the second motor/generator 40 can be locked together and driven at the same speed by locking the power splitter by engaging the second clutch so that the vehicle can be driven by the motors only. Therefore, it is possible to maximize the fuel efficiency even at high speed because it is possible to travel at high speed in electric mode.

It is possible to drive the vehicle in the fixed gear shift stage mode in a driving condition in which a load exceeding the thermal capacity of the electric motor is applied, so that stable and quiet driving is possible.

Particularly, the vehicle can be driven in the fixed gear shift stage mode by the engine only without any trouble even when the battery is discharged during driving on the long-distance steep slope so that the performance requirement of the driver can be satisfied in the various drive condition.

In the downhill driving, when the battery cannot be charged while the battery is fully charged, the engine brake can be operated in the fixed gear shift stage mode.

By making it possible to selectively couple the second motor/generator to the main shaft or the output shaft as in the second embodiment, it is possible to maximize the instantaneous acceleration force in the fixed gear shift stage mode at high speed.

### BRIEF DESCRIPTION OF THE DRAWINGS

FIG. 1 is a conceptual diagram showing a transmission configuration of a hybrid vehicle according to the first embodiment.

FIG. 2 is a conceptual diagram of the hybrid transmission of the first embodiment without the first clutch CL1.

FIG. 3 is a conceptual diagram of the hybrid transmission of the first embodiment in which the first clutch CL1 is provided.

FIG. 4 shows an example of a modified hybrid transmission power splitter of the first embodiment.

FIG. 5 shows an example of a hybrid transmission in which a planetary reducer is added between a carrier and a sun gear.

FIG. 6 shows the arrangement of the sun gears, ring gear, idler and planet gears of the modified power splitter of FIG. 4.

FIG. 7 is a table showing the relationship between the elements for shift and the mode in the first embodiment in which the first clutch CL1 is not provided.

FIG. 8 is a table showing the relationship between the elements for shift and the mode of the first embodiment in which the first clutch CL1 is provided.

FIG. 9 is a conceptual diagram showing the EV1 mode.

FIG. 10 is a lever diagram in EV1 mode.

FIG. 11 is a conceptual diagram showing the EV2 mode.

FIG. 12 is a lever diagram in the EV2 mode.

FIG. 13 is a conceptual diagram showing the EV3 mode.

FIG. 14 is a lever diagram in EV3 mode.

FIG. 15 is a conceptual diagram showing the EV4 mode.

FIG. 16 is a lever diagram in EV4 mode.

FIG. 17 is a conceptual diagram showing the HV mode.

FIG. 18 is a lever diagram in the HV mode.

FIG. 19 is a conceptual diagram showing the MV1 mode.

FIG. 20 is a conceptual diagram showing the MV2 mode.

FIG. 21 is a conceptual diagram showing the MV3 mode.

FIG. 22 is a table showing an example of the relationship between the driving speed and the engine rotational speed in the fixed gear shift stage mode (MV mode).

FIG. 23 is a conceptual diagram showing an example in which a ring gear and a brake are added to the power splitter of the hybrid transmission of the present invention.

FIG. 24 is a conceptual diagram showing a configuration of a hybrid transmission of the present invention having a splitter including a triple planet gear and three ring gears.

FIG. 25 is a conceptual diagram in which two motors/generators of the hybrid transmission of the present invention are arranged on one side as a group separated from a power splitter.

FIG. 26 is a conceptual diagram of the hybrid transmission of the present invention applied to rear wheel drive.

FIG. 27 is an example of a hybrid transmission in which two motors/generators are arranged as a group and applied to rear wheel drive derived from the hybrid transmission of the present invention.

FIG. 28 shows an example of modified configuration of FIG. 27.

FIG. 29 is a conceptual diagram of the hybrid transmission of the second embodiment in which the second motor/generator is connected to the main shaft.

FIG. 30 is a conceptual diagram of the hybrid transmission of the second embodiment in which the second motor/generator is arranged closer to the engine than the first motor-generator.

FIG. 31 is a chart showing the relative relationship between the required torque and the output torque at the time of maximum acceleration in the fixed gear shift stage mode in the first embodiment and the second embodiment.

FIG. 32 is a conceptual diagram of a hybrid transmission implementing a method of simultaneously or selectively connecting the second motor/generator to the main shaft or the output shaft.

### DETAILED DESCRIPTION OF THE INVENTION

The numbers assigned to the elements in the drawings are assigned with the same numerals in the other drawings if the corresponding elements have the same function.

Hereinafter, embodiments of the present invention will be described in detail with reference to the drawings.

However, the present invention is not limited by these examples. In addition, the constituent elements of the following embodiments can be substituted with various types of elements having the same purpose function as those skilled in the art can think of.

That is, any device which can stop or release the movement of the rotational elements such as dry/wet disc brake, electric/electronic brake, band brake, expanding brake, dog brake, etc. can be used as a brake. These brakes can be operated hydraulically, mechanically, electromagnetically, by combination of the spring and hydraulic device or by combination of the spring and electromagnetic device.

For the clutches, various well-known types of clutches such as a dry/wet disk clutch, a dog clutch, and an electronic clutch, etc. can be applied.

An oil pump is connected to one end of the main shaft 11 connected to the engine to supply lubricating oil/pressure oil to the friction surfaces or the gear engaging surfaces of the hybrid transmission. Alternatively, the oil pump may be driven by a separate electric motor not shown in the drawing, or an oil pump may be connected to the PTO shaft of the engine timing gear not shown in the figure to supply lubricating oil or hydraulic oil.

In case of using the dog clutch, the two rotational elements coupled by the clutch can be engaged smoothly with each other at the time that the rotational speeds of the two elements are synchronized by the control device and then combined. Even in case of adapting other clutch mechanisms, engaging impact and wear can be minimized if synchronized engagement achieved.

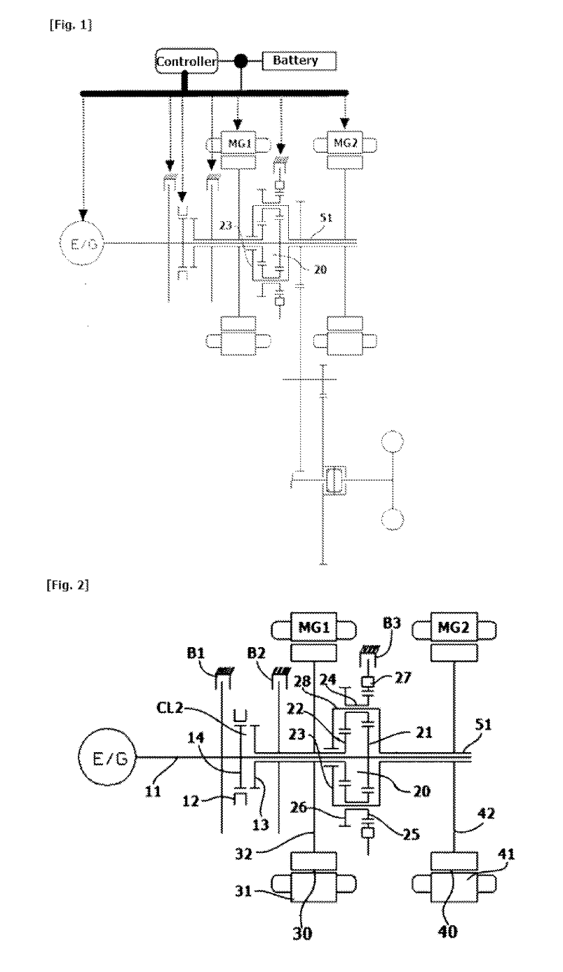

A conceptual diagram of the configuration of the first embodiment of the present invention is shown in FIG. 1

In the configuration of FIG. 1, the control unit collects various driving data of the vehicle through various sensors not shown in the drawings, and based on these data, the control unit controls the vehicle speed by controlling the engine and the motor/generator with optimum gear ratio according to the intention of the driver through an inverter and etc. not shown in the figure.

The engine as a power source transmits power through the rotational shaft 11. The first motor/generator 30, the second motor/generator 40 and the power splitter 20 are installed coaxially with the rotational shaft 11 and the engine power is transmitted to the driving shaft through the output shaft 51 connected integrally to the carrier 23 of the power splitter 20 and then the vehicle can be driven. The output shaft 51 may transmit the power to the driving shaft via the final reduction gear and the differential device or to the differential device directly from the carrier 23, which is applicable to the rear-wheel drive vehicle.

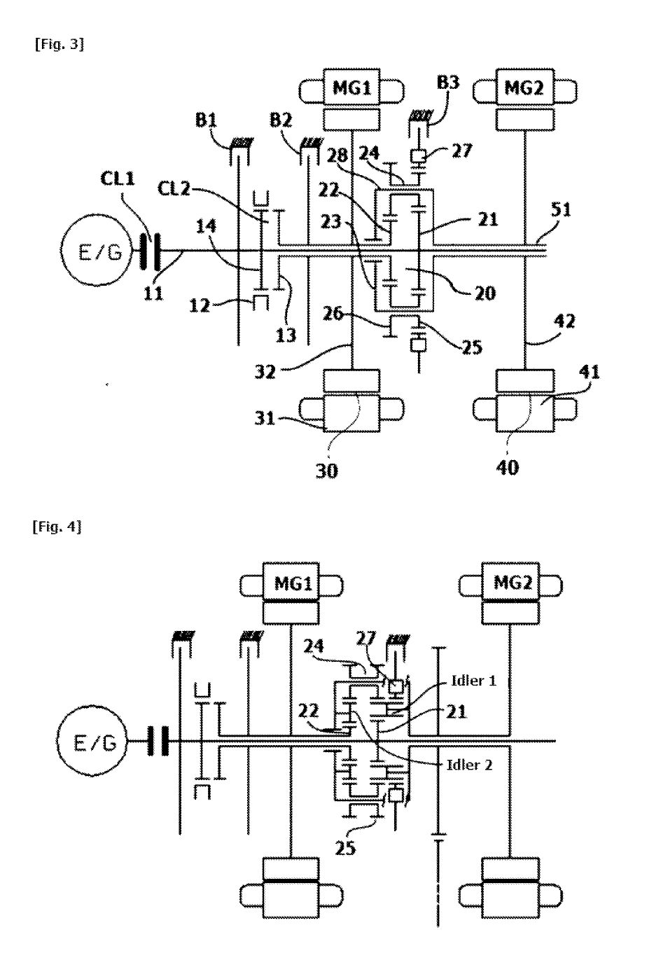

FIG. 2 and FIG. 3 show the remaining part of FIG. 1 except the control part and the traveling part. As shown in FIG. 2, the hybrid transmission of the present invention includes a main shaft 11, a power splitter 20, a second clutch CL2, a first brake B1, a second brake B2, a third brake B3, a first motor/generator 30, a second motor/generator 40, and an output shaft 51.

The first brake B1 is connected to the main shaft 11 to be able to stop the rotation of the main shaft 11 and the second brake B2 is engaged with the sun gear 22, and the shaft of the rotor 32 of the first motor/generator 30 to be able to stop the rotation of the sun gear 22 and the rotor 32 of the first motor-generator. The third brake B3 is connected to the first ring gear 27 to be able to stop the rotation of the first ring gear 27.

The feature of FIG. 3 is the same as that of FIG. 2 except that the first clutch CL1 is added.

The power splitter 20 includes a sun gear 21 and a sun gear 22; a gear 25 meshing with the sun gear 21 and a gear 26 meshing with the sun gear 22; a dual planet gear 24 having both ends of the gear 25 and the gear 26; planet gear shafts 28 as a rotation center shaft of the dual planet gear 24; a carrier 23 receiving the sun gear 21, the sun gear 22, the dual planet gear 24 and the planet gear shaft 28 supporting the dual planet gear 24; and the first ring gear 27 meshing with the gear 25 of the dual planet gear 24. The first ring gear 27 may be configured to engage with the gear 26 of the dual planet gear 24.

In the hybrid transmission of the present invention, the number of pairs of gears in a gear train between the two sun gears of the power splitter 20 is an even number. The power splitter 20 of the hybrid transmission shown in the embodiment of the present invention shown in FIGS. 2 and 3 has two pairs of gears between the sun gear 21 and the sun gear 22, but it is possible to have four or more even numbers of pairs of gears by utilizing idler 1 and idler 2 as required. In this case, the even number of idlers are not necessarily divided into the same number on both sides.

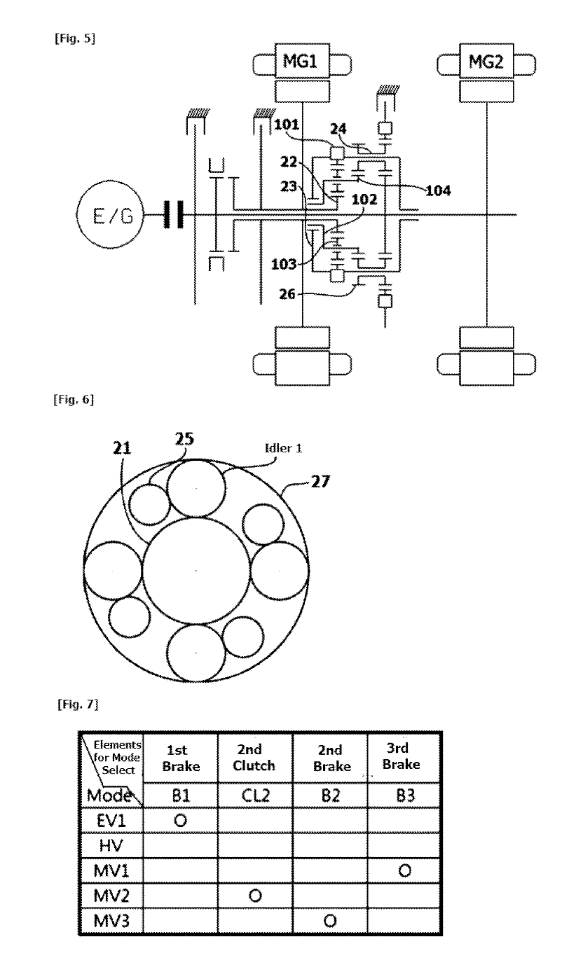

For example, when the number of teeth of the gears at both ends of the dual planet gears 24 are different, it is some difficult to manufacture the gears. In the case of composing with the idler 1 and the idler 2 interposed therebetween, the manufacturing process of the dual planet gear can be simplified with the same number of teeth of the gear 25 and the gear 26. However, in this case, the first ring gear 27 is connected to the idler 1 which directly connects to the sun gear 21, or to the idler 2 which is directly connected to the sun gear 22. FIG. 6 shows an example in which the idler 1, the sun gear 21, the gear 25 and the first ring gear 27 shown in FIG. 4 are connected.

FIG. 5 shows the dual planet gear 24 with same numbers of teeth for the gear 25 and the gear 26 at both ends of it and an additional planetary gear set instead of idlers between the sun gear 22 and the planet gear 26. With this configuration, the same effect can be obtained. Referring to FIG. 5, the ring gear 101 added is integrally assembled to the carrier 23, and the sun gear 22 rotates in mesh with the planet gear 103, and the additional sun gear 104 is integrally assembled to the carrier 102 and meshes with the planet gear 26. With this configuration, the same effects as those targeted in FIG. 2 to FIG. 4 can be obtained without interposing the idler 1 and the idler 2 as in FIG. 4.

The first motor/generator 30 and the second motor/generator 40 have the functions of a motor and a generator, and are connected to the battery through an inverter. In the case of functioning as a motor, the power of the battery is converted into a mechanical rotational power, and in the case of functioning as a generator, the input power is converted into electric power to charge the battery. In some cases, the power generated by the generator is directly supplied to the motor as an assist power source, thereby reducing the efficiency deterioration due to the charge and discharge of the battery.

In the event that an assist power is required in addition to the engine (EG) power, such as when accelerating or driving on a steep slope, one of the first motor/generator 30 and the second motor/generator 40 functions as a generator and another functions as a power assist device as a motor, the motor/generator functioning as a motor according to the load exceeded the engine power may generate mechanical rotational power by using electric power from the battery and electric power generated from other motor-generator.

The second clutch CL2 can connects or disconnects the main shaft 11 and the sun gear 22 so that it restrains or permits the relative movement between the carrier 23 and the first ring gear 27, and it leads the mode to be converted.

The second clutch CL2 may be provided to connect or disconnect the main shaft 11 and the carrier 23 or to connect or disconnect the sun gear 22 and the carrier 23.

The first motor/generator 30 has a stator 31 and a rotor 32 and the second motor/generator 40 has a stator 41 and a rotor 42.

The rotor 32 rotates integrally with the sun gear 22, and the rotor 42 rotates integrally with the carrier 23.

The first brake B1, the second brake B2 and the third brake B3 can be used for mode conversion by stopping or releasing the main shaft 11, the sun gear 22, and the first ring gear 27 respectively.

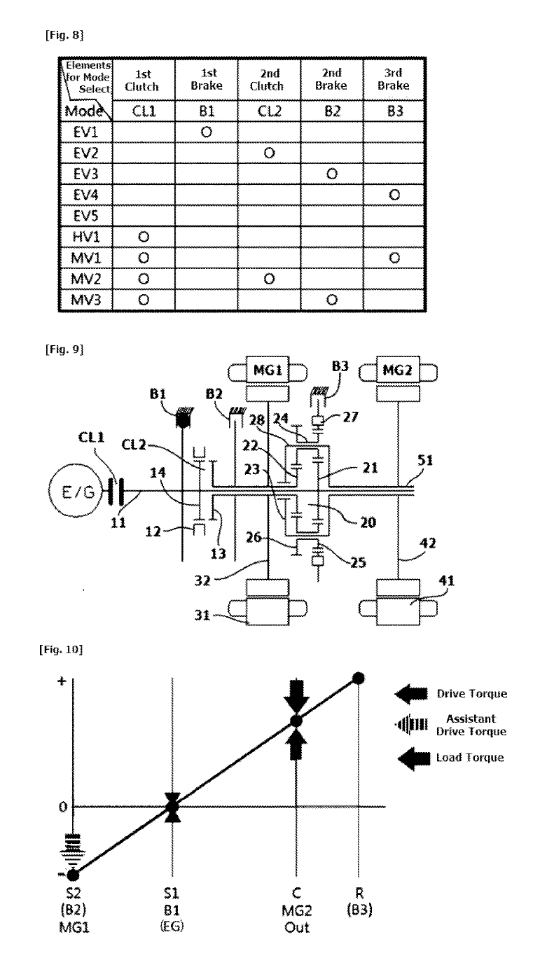

FIG. 7 and FIG. 8 show the mode conversion according to the engagement and releasing of the first clutch CL1, the second clutch CL2, and the first brake, the second brake, and the third brake

In the FIG. 7 and FIG. 8, the symbol “O” indicates the engaged state of the corresponding clutch or brake, and the blank indicates the releasing state of the corresponding clutch or brake

The EV mode is an electric motor driving mode in which the engine EG is stopped. For this mode, in the case of the hybrid transmission having the first clutch CL1, the first clutch CL1 is released and in the case of the hybrid transmission without the first clutch CL1, the first brake B1 is engaged.

The EV mode in the hybrid transmission without the first clutch CL1 as shown in FIG. 2 includes only the EV1 mode in which the first brake B1 is engaged, and in the hybrid transmission having the first clutch CL1 as shown in FIG. 3, there may be five modes of the EV1 mode to the EV5 mode.

The hybrid mode (HV) is one HV mode, and the fixed gear shift stage mode may exist in three modes, MV1 mode to MV3 mode, which is the same as in the hybrid transmission of FIG. 2 and FIG. 5.

FIG. 9 to FIG. 21 show a conceptual diagram and a lever diagram of a hybrid transmission in engaged or released state of the clutches and brakes for each mode. In the diagrams, the symbol “•” indicates that the corresponding clutches or the corresponding brakes are engaged, and other clutches or brakes without the symbol “•” are released.

The state of the hybrid transmission without the first clutch CL1 is the same as the state in which the first clutch CL1 is engaged in the hybrid transmission having the first clutch CL1, and thus hereinafter, explanation on the hybrid transmission having the first clutch CL1 like as shown in FIG. 3 will be described.

A vehicle equipped with the hybrid transmission of the present invention can be driven by selecting one of hybrid traveling mode, traveling by an electric motor driving mode, or traveling by a fixed gear shift stage mode.

FIG. 22 is a chart showing the relationship between the traveling speed of each mode and the engine speed in the fixed gear shift stage mode in the first embodiment. As shown in this chart, the fixed gear shift stage mode has three modes.

### EV1 Mode

As shown in the FIG. 9, in the EV1 mode, when the first brake B1 is engaged, the sun gear 21 is in a stopped state, and the vehicle can be driven by the second motor/generator 40 as a main power source, which is integrally coupled to the output shaft 51. And the first motor/generator 30 idles in the reverse direction, and the first ring gear 27 idles in the forward direction. If the driving power from the main power source does not reach the load required for driving in the case of driving on a steep slope or with acceleration, or if excessive heat is generated and the temperature of the second motor/generator exceeds the limit value, the first motor/generator 30 is used as an assist power source, the load can be dispersed to suppress excessive heat generation, and the insufficient driving power can be supplemented.

In the EV1 mode, the rotational speeds of the first motor/generator 30 and the second motor/generator 40 are different from each other, so that the gears in the power splitter 20 relatively move, resulting in gear friction loss. Therefore, the EV1 mode is valuable only in the hybrid transmission without the first clutch CL1. However, in order to engage the first clutch CL1 to drive the engine EG during the EV mode running in the hybrid transmission having the first clutch CL1, since it is desirable to engage the first clutch CL1 at the time that the speed of the main shaft 11 is set to 0 to be synchronized, the EV1 mode is valuable as a transitional mode for engaging the first clutch CL1.

FIG. 10 is a lever diagram in the EV1 mode. In all the lever diagrams including FIG. 10, S1 represents the sun gear 21, S2 represents the sun gear 22, B1, B2 and B3 represent the first brakes, the second brake, the third brake respectively, R represents the first ring gear 27, C represents the carrier 23, and Out represents the output. (B1), (B2), and (B3) indicate release states, and B1, B2, B3 without ( ) indicate the engaging state. Also, (EG) indicates that the engine is in a stopped state, and EG indicates that the engine is in a running state.

In the lever diagram of this specification, the rotational direction of the main shaft 11 is set to the positive direction (+), the drive torque is indicated by the gray arrow, the load torque is indicated by the black arrow. And the drive torque in the positive direction is indicated by an upward arrow in the drawing. The load torque in the positive rotation is shown with negative (−). A full gray arrow indicates the main drive torque, and an intermittent gray arrow indicates the assist drive torque.

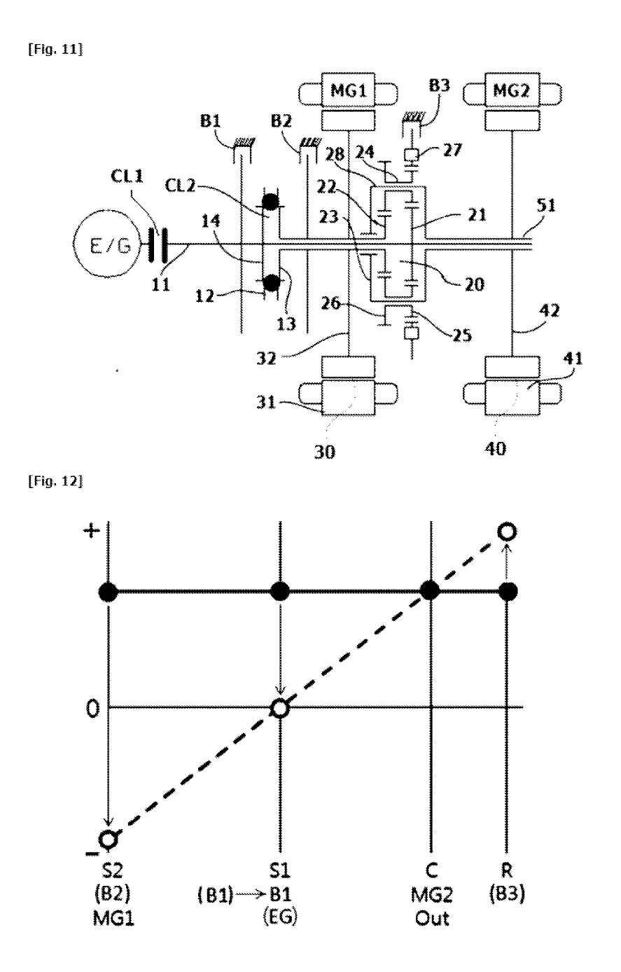

The state of EV2 is shown in FIG. 11. In EV2 mode, all the driving elements of the power splitter 20 are rotated integrally by the second clutch CL2. Therefore, depending on the required load, one or both of the first motor/generator 30 and the second motor/generator 40 may be operated as the power sources. And there is no gear friction loss in the power splitter 20 due to the fact that the gears in the power splitter 20 do not make a relative motion, which is the most desirable EV mode. However, idling motor/generator generates dragging losses, so it is efficient to drive properly the two motor/generator according to the load and the required rotational speed.

FIG. 12 is a lever diagram that shows the changes from EV2 mode to EV1 mode. The solid line is the lever diagram of the EV2 mode, and the dotted line is the lever diagram of the EV1 mode. When the engine EG is need to be started, such as the state of reaching the battery discharge limit, while traveling in the EV2 mode, as described in the explanation of the EV1 mode, the main shaft 11 is preferable to be set the rotational speed to zero before engaging the first clutch CL1. At this time, the sun gear 22 and the rotor 32 of the first motor/generator 30 rotate in the reverse direction, and the first ring gear 27 is driven faster than before in the normal rotation direction

There are two methods for decelerating the rotational speed of the main shaft 11 to the stop state in the EV2 mode. The first method is to drive the first motor/generator 30 in the reverse rotation after operating it as a generator until the first motor/generator 30 is stopped after releasing the second clutch CL2. The second method is to operate the first brake B1 to stop the main shaft 11 after releasing the second clutch. Practically, it is preferable to mix the two methods appropriately depending on the situation.

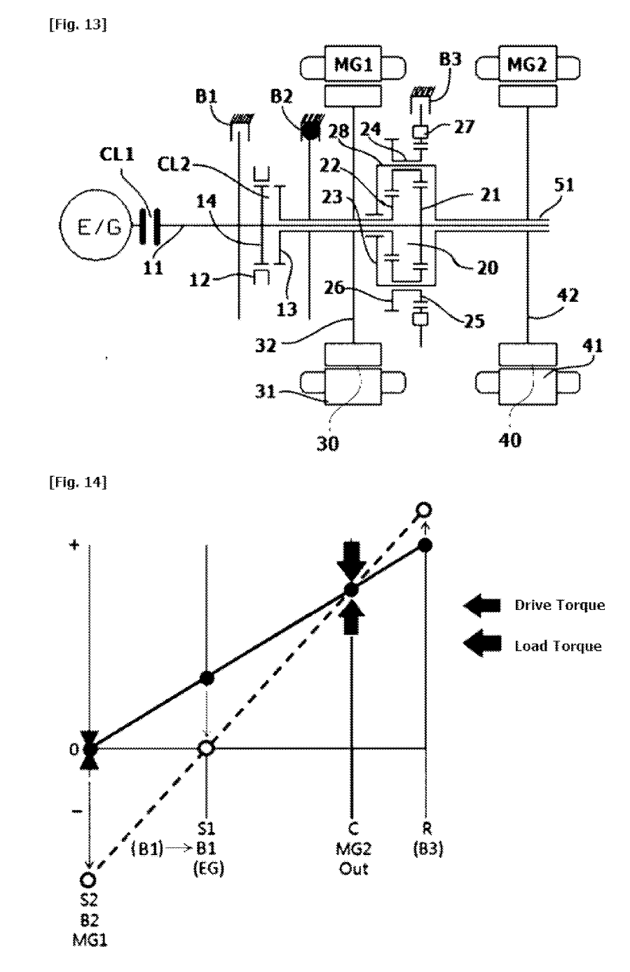

The state of the EV3 mode is shown in FIG. 13. As shown in FIG. 13, in the EV3 mode, the first clutch CL1 is released and the second motor/generator 40 is operated as a power source in a state where the second brake B2 is engaged. In this case, there is no drag loss of the first motor/generator 30 because the first motor/generator 30 is in the stopped state. However, since the first clutch CL1 is in released state, there is no obstacle in traveling by the second motor/generator 40 even if the second brake B2 is not engaged. Further, since the vehicle is driven in a state in which each idling component are rotating in a balanced state by torque caused by the drag of the first motor/generator 30, the gear friction in the power splitter 20, and oil resistance, eventually, EV3 mode becomes EV5 mode.

FIG. 14 is a lever diagram in EV3 mode. In case that the engine (EG) is needed to be started to switch from EV3 mode to HV mode or MV mode, the dotted line in the lever diagram shows a change in the rotational speed of the rotational element when switching to the EV1 mode as a transient for synchronously coupling the first clutch CL1,

The state of the EV4 mode is shown in FIG. 15. In the EV4 mode, the first clutch CL1 is released, and the first motor/generator 30 is operated as the main power source in the state where the third brake B3 is engaged. The second motor/generator 40 may be operated as an assist power source if necessary. When the brake B3 is engaged, the first ring gear 27 is stopped and then the power splitter 20 is switched to the planetary gear reducer composed of the sun gear 21, the planet gear 24, the first ring gear 27 and the carrier 23. Therefore, the accelerating force is increased at the time of starting acceleration because of the large reduction ratio. Accordingly, it is possible to solve the problem of insufficient starting acceleration, which is one of the complaints to the hybrid vehicle.

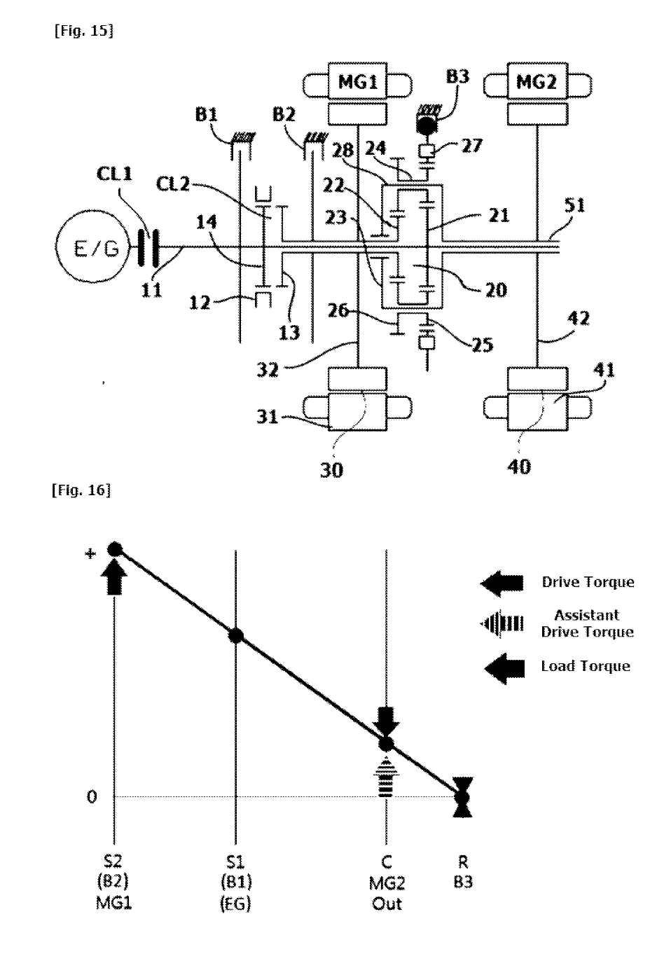

FIG. 16 is a lever diagram in EV4 mode. The torque acting point of the first motor/generator 30 is farthest from that of the stationary first ring gear 27 as shown in the above diagram. That is, the drive torque transmitted to the output shaft 51 with the high reduction ratio becomes very large, and if necessary, the driving force of the second motor/generator 40 can be added up, so that the starting acceleration force becomes sufficient.

In EV5 mode, all brakes and clutches are released. At this time, the second motor/generator 40 becomes the main power source, and the first motor/generator 30 idles.

The most preferable EV mode is an EV2 mode. The EV5 mode is only valuable as a transition EV mode that switches to the EV1 mode to start the engine (EG) to switch to the hybrid mode or the fixed gear shift stage mode while driving in the EV mode.

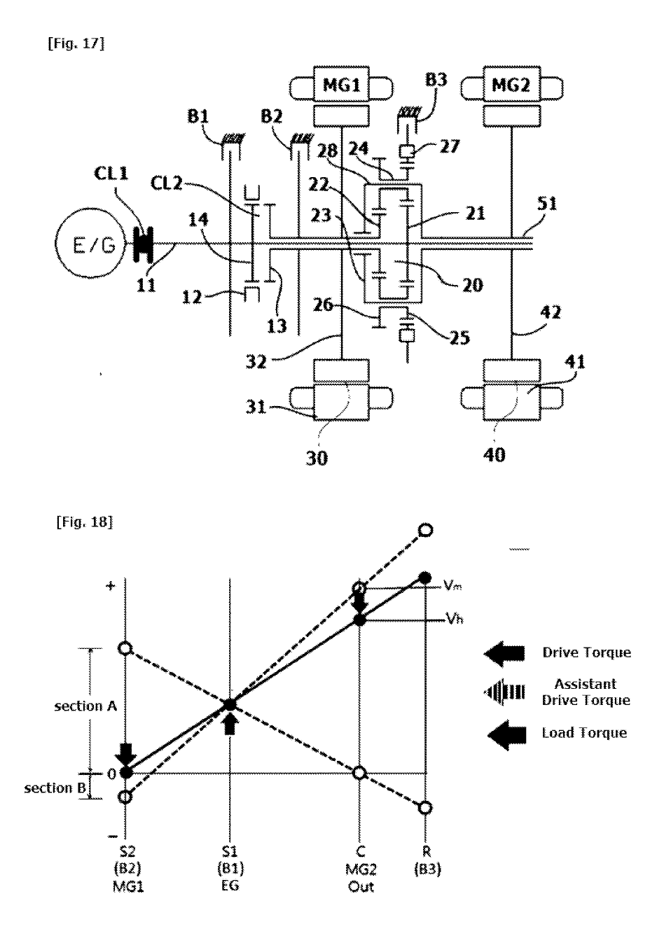

FIG. 17 shows the state of the HV mode. The HV mode is a hybrid mode. When the first clutch CL1 is engaged, the second clutch CL2 and all the brakes B1, B2, and B3 are released, the transmission enters the HV mode. In the hybrid mode, the engine EG serves as a main power source, and the first motor/generator 30 mainly functions as a generator and the second motor/generator 40 functions mainly as a motor in accordance with driving conditions. Or, depending on the load conditions and the engine speed, one or both of the two motor/generator may function as a generator or a drive motor as an assist power source.

FIG. 18 is a lever diagram in HV mode. If the vehicle speed Vh is a speed at which the rotational speed of the first motor/generator 30 becomes zero at the engine (EG) constant speed at which the fuel efficiency is the best and If the vehicle speed (Vm) is the maximum speed at which the vehicle can travel in the HV mode at a constant engine (EG) speed with the best fuel efficiency, section A is a section in which the first motor/generator 30 functions as a generator, and section B is a section in which the first motor/generator 30 functions as a drive motor. The ranges of the section A and the section B depends on the reduction ratio from the output shaft 51 to the drive wheel and the reduction ratio between the sun gear 21 and the sun gear 22 in the power splitter 20.

Of course, the first motor/generator 30 does not generate the electric power and the driving power at the point where the section A and the section B meet, that is, the rotational speed of the first motor/generator 30 becomes zero.

The MV mode is a fixed gear shift stage mode and the vehicle can be driven using the engine EG as a power source without intervention of the first motor/generator 30 and the second motor/generator 40. The first motor/generator 30 and the second motor/generator 40 may of course function as a generator or an assist drive motor as occasional demands. Alternately, it is possible to synchronize the rotational speeds of the main shaft 11 and the sun gear 22 when the second clutch CL2 is engaged for switching from other mode to the MV2 mode.

During the vehicle travels in steep slopes for a long time in EV mode or HV mode, if the driving power is limited by the heat of the motor/generator or if the battery is discharged, the well-known hybrid vehicle may become difficult to drive on that road or the acceleration performance is also limited. In the hybrid transmission of the present invention, when such a restriction occurs, the hybrid vehicle can be operated in the fixed gear shift stage mode without assistance from the electric power.

FIG. 22 shows an example of the relationship between the rotational speed of the engine EG and the travel speed in the fixed gear shift stage mode. According to this, in the fixed gear shift stage mode, the hybrid transmission of the present invention can be expected to exhibit the same function as the manual or automatic transmission having three speed change gears.

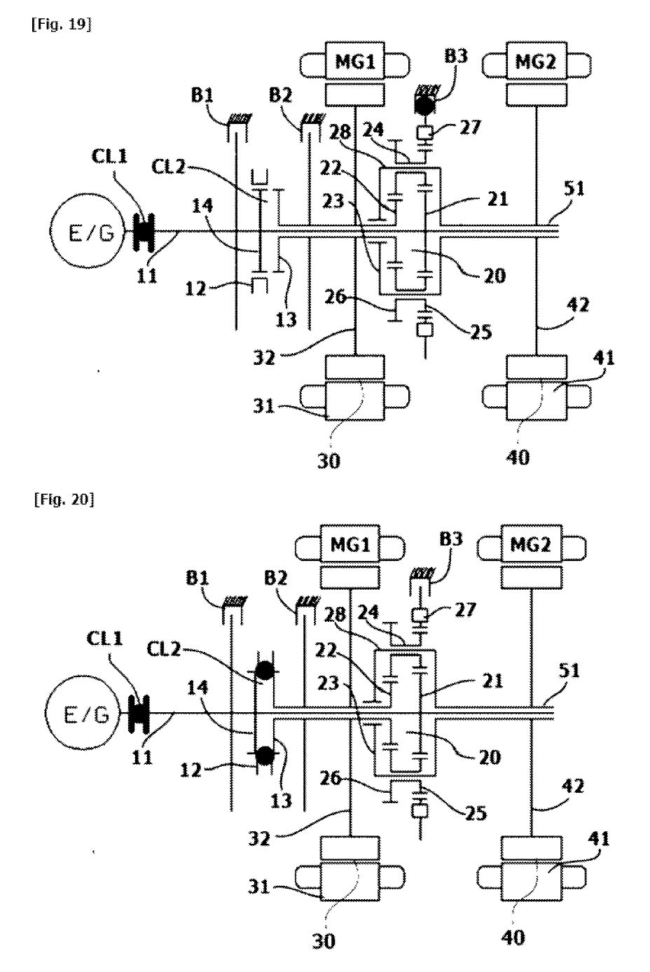

As shown in the FIG. 19, the vehicle equipped with the hybrid transmission of present invention can be driven when the first clutch CL1 is engaged and the first ring gear 27 is stopped by the engaged brake B3 in the MV1 mode. In the MV1 mode, the power splitter 20 functions as a planetary gear reducer composed of the sun gear 21, the planet gear 25 and the first ring gear 27 and the carrier 23, It becomes the 1st gear with the greatest reduction ratio among the 3 gears.

As shown in FIG. 20, in the MV2 mode, the first clutch CL1 and the second clutch CL2 are engaged so that the vehicle can travel while the power splitter 20 are integrated as the second gear with 1:1 gear ratio of the fixed gear shift stage mode. In the MV2 mode, there is no gear friction loss in the power splitter 20 because there is no relative movement of the gears in the power splitter 20.

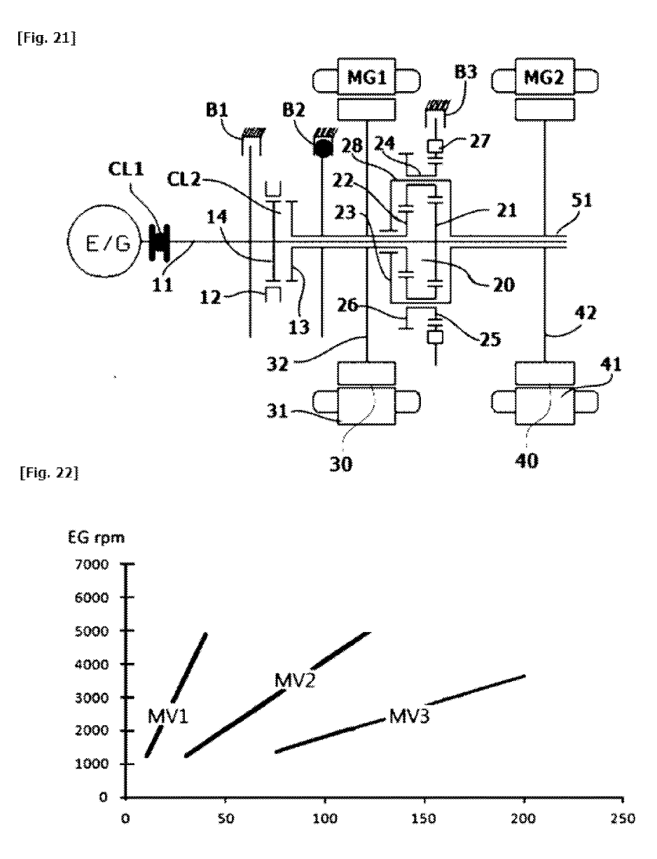

As shown in FIG. 21, in the MV3 mode, the second brake B2 is engaged in a state in which the first clutch CL1 is engaged, so that the vehicle can travel. In the MV3 mode, the transmission enters in the overdrive state and becomes the fastest multi-step speed change stage among the three gears. In this case, since the first motor/generator 30 is in a stopped state, only the second motor/generator 40 can be operated as a assist power source when additional power is required during acceleration.

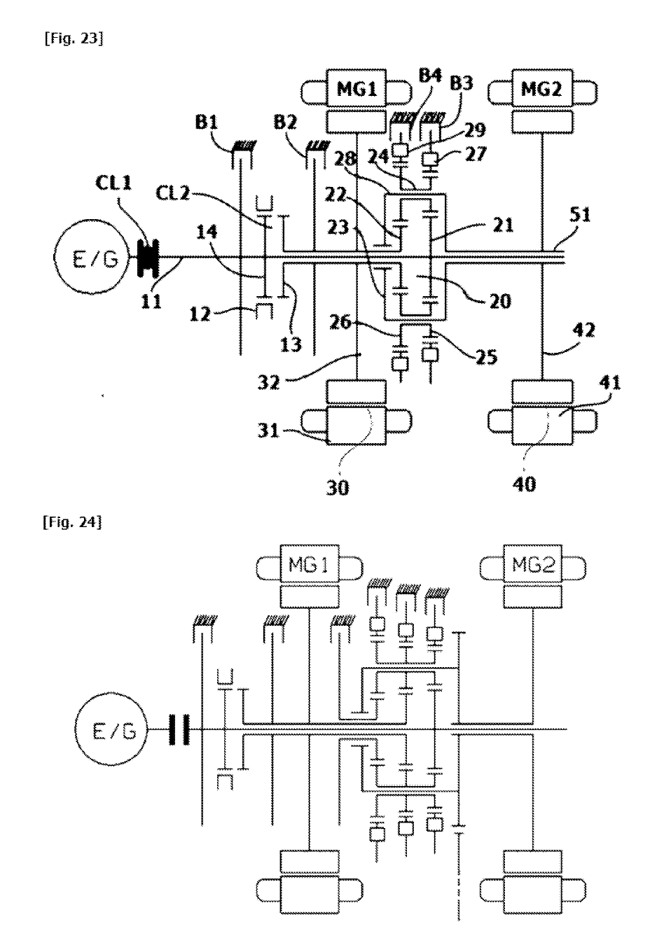

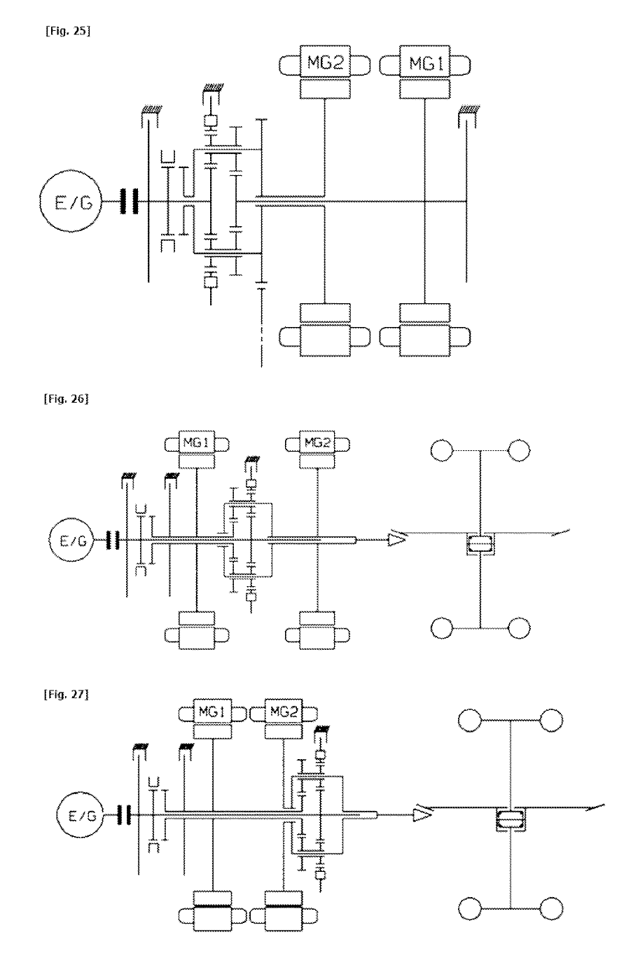

FIG. 23 shows s variation in which the second ring gear 29 and the brake B4 for controlling the second ring gear 29 are added. The second ring gear is meshing with the gear 26 of the double planet gear 24 of the power splitter 20 in the first embodiment. These added components can perform the same function as the first ring gear 27 and the third brake B3. That is, it is obvious that they can be used to realize additional EV mode and MV mode. It is also clear that the use of triple or quadruple planet gears instead of dual planet gears in this way enables more detailed EV and MV modes. FIG. 24 shows another variation which has sun gears, brakes and triple planet gears with ring gears meshing with each gear on the triple planet gear.

FIG. 25 shows a method of collecting and installing the first motor/generator 30 and the second motor/generator 40 in one place in the hybrid transmission of the present invention. This has the advantage of being easy to modularize, since the electrical and mechanical components can be installed separately.

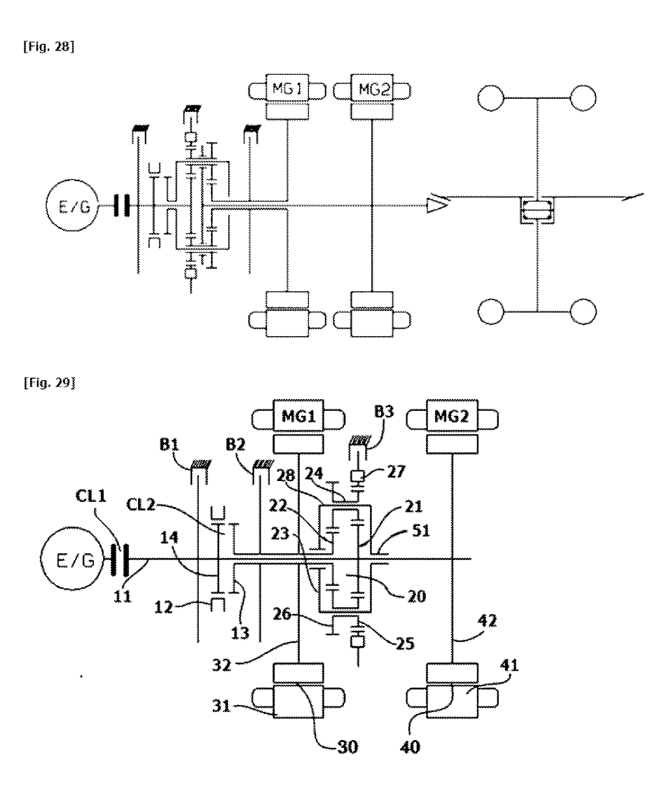

FIG. 26, FIG. 27 and FIG. 28 show a method of arranging the direction of the rotational axis of the hybrid transmission according to the present invention in the front-rear direction of the vehicle. This arrangement is mainly applicable to a rear-wheel drive vehicle, and it shows that the hybrid transmission of the present invention can be applied to a rear-wheel drive vehicle without difficulty.

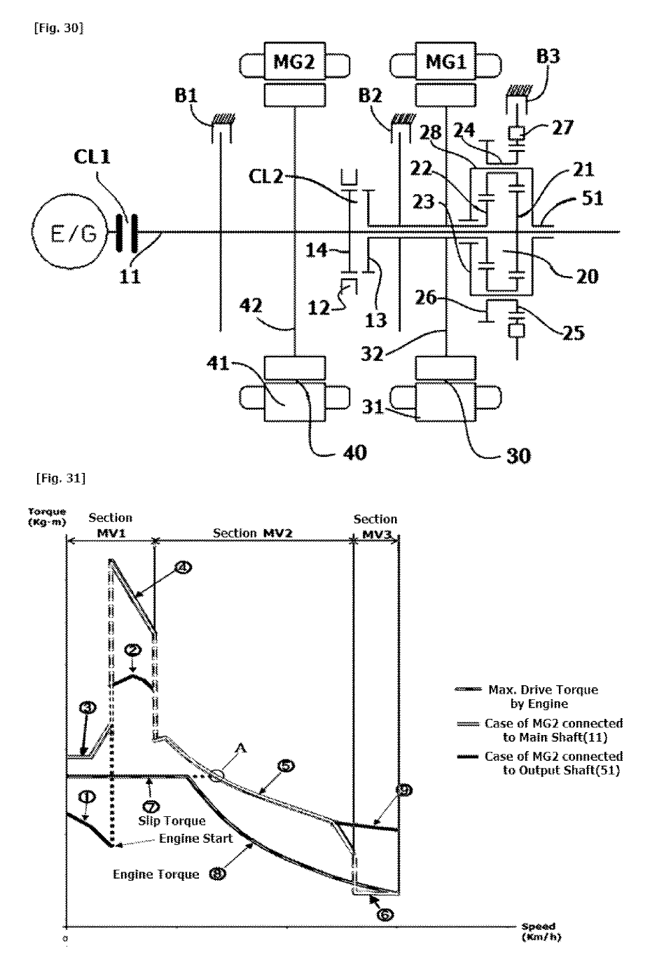

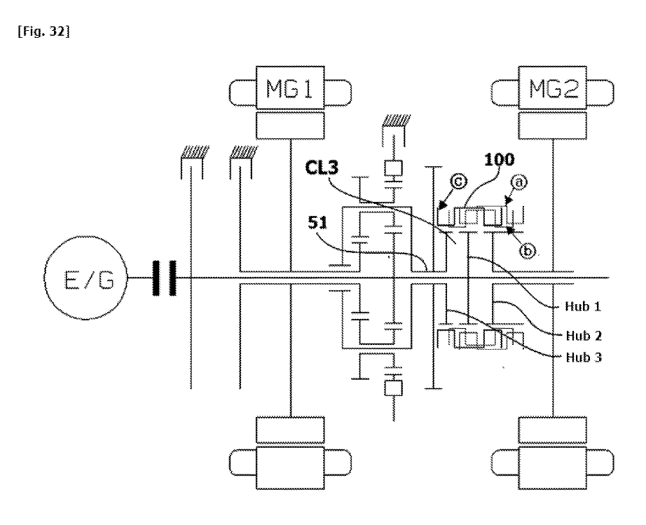

FIG. 29 and FIG. 30 show a second embodiment of the present invention in which a second motor/generator is installed on the main shaft connected to an engine so as to drive the power splitter by a second motor/generator with utilizing functions of the power splitter as a speed reducer and a speed increaser in the EV mode and the fixed gear shift stage mode.

In the first embodiment, the second motor/generator is integrally connected to the output shaft 51 so that the power (or torque) is transmitted to the drive wheels at a predetermined reduction ratio. Therefore, in the EV mode and the fixed gear shift stage mode, it is difficult to obtain a satisfactory torque necessary for a high acceleration performance in a low-speed range.

In the second embodiment, by connecting the second motor/generator to the main shaft, the output and the size of the second motor/generator 40 are kept small, and at the time of starting in the EV mode or in the fixed gear shift stage mode, high output torque can be obtained even in the low speed range.

Since the second embodiment only changes the shaft on which the second motor/generator is installed, the operation of the brake and the clutch that implement the EV mode, the hybrid mode, and the fixed gear shift stage mode is the same as in the first embodiment.

FIG. 31 shows the relative relationship between the required torque and the output torque at the time of maximum acceleration in the fixed gear shift stage mode in the first embodiment and the second embodiment.

In FIG. 31, \textcircled{1} is the drive torque by the MG2 from the stop state to the start of the engine in the MV1 mode section in the fixed gear shift stage mode in the first embodiment, \textcircled{2} is the driving torque by the engine and the MG2 after the engine is started in the MV1 mode, \textcircled{3} is the driving torque by the MG2 from the stop state to the start of the engine in the MV1 mode in the second embodiment and \textcircled{4} is the driving torque supplied by the engine and the MG2 in the MV1 mode in the fixed gear shift stage mode in the second embodiment and the driving torque by the engine and the MG2 after the engine is started. \textcircled{5} is driving torque by the engine and the MG1 and the MG2 in the MV2 mode section in the fixed gear shift stage mode in the second embodiment, which is the same as in the MV2 mode section in the fixed gear shift stage mode in the first embodiment. \textcircled{6} is the driving torque by the engine and the MG2 in the MV3 mode section in the fixed gear shift stage mode in the second embodiment, and \textcircled{9} is the same as in the MV3 mode section in the fixed gear shift stage mode in the first embodiment. \textcircled{7} and \textcircled{8} show the output torque curve when the vehicle is driven only by the engine, assuming with an ideal continuously variable transmission. Point A is the intersection of the output curve \textcircled{5} and the slip torque line \textcircled{7} in the multi-step speed mode MV2 section.

When accelerating the vehicle at maximum acceleration, the acceleration of the vehicle is limited by the slip torque up to point A, and then the vehicle is accelerated along the curve \textcircled{5} and curve \textcircled{6}. This graph shows that the vehicle equipped with the hybrid transmission according to the second embodiment exhibits a strong acceleration performance as compared with the vehicle equipped with the hybrid transmission in the first embodiment from at rest to at the time of engine starting. It can exhibit much better acceleration performance than a general transmission vehicle equipped with an engine of the same output.

Though it depends on the design factors such as the output of the engine and the motor-generator, and reduction ratio, the weight of the vehicle and etc., the point at which the fixed gear shift stage mode MV3 section begins is roughly at 130-140 km/h in the second embodiment.

In the fixed gear shift stage mode MV3 section, the acceleration performance is insufficient compared to the MV3 mode section in the fixed gear shift stage mode in the first embodiment, but is not significantly lower than that of a vehicle equipped with a general transmission, and is practically acceptable.

However, in order to solve this problem, as shown in FIG. 32, the clutch CL2 is installed between main shaft 11 and the output shaft 51 so that the rotor 41 of the second motor/generator 40 can be connected to the output shaft 51. And the rotor 41 of the second motor/generator 40 is provided freely rotatable on the main shaft 11, and the clutch CL3 is installed between the main shaft 11 and the rotor 41 of the second motor/generator 40 so that the rotor 41 of the second motor/generator 40 can be connected to the main shaft 11 in the MV3 mode.

This will be described in detail with reference to FIG. 32. In the MV1 mode, the sleeve 100 connects the hub 1 and the hub 2 at the position \textcircled{a}, so that the second motor/generator 40 is connected to the main shaft 11 to achieve the maximum acceleration torque. When the sleeve 100 moves to the position \textcircled{b}, the hub 1, the hub 2 and the hub 3 are connected at the same time, so that the power splitter 20 is integrated to achieve the MV2 mode. When the sleeve 100 moves to the position \textcircled{c}, The hub 2 and hub 3 are connected so that the second motor/generator 40 is connected to the carrier, the output shaft 51 so that the maximum output torque in the MV3 mode follows the curve \textcircled{9} shown in FIG. 8.

What is claimed is:

1. A transmission for a hybrid vehicle,
the transmission including a first motor/generator, a second motor/generator, and a power splitter, and connected to an engine,
wherein the first motor/generator serves mainly as a primary generator, and the second motor/generator serves mainly as an assistant power motor, wherein the power splitter includes:
a dual planet gear, a first ring gear, a first sun gear, and a second sun gear; and
a carrier for housing the dual planet gear, the first sun gear and the second sun gear,
wherein the engine is connected to the first sun gear via a main shaft, and a rotational shaft of the first motor/generator is connected to the second sun gear,
wherein a rotational shaft of the second motor/generator is connected to the first sun gear or integrally connected to the carrier,
wherein the output shaft is integrally connected to the carrier of the power splitter,
wherein the first ring gear meshes with one of the first and second planet gears, and the third brake is on the first ring gear,
and wherein the first ring gear is configured to idly rotates without being applied with any reaction force other than when the third brake is engaged thereto.

2. The transmission of claim 1, further comprising a second clutch that is configured to couple or decouple the two of four rotational elements of the power splitter to lock or unlock the power splitter.

3. The transmission of claim 1, further comprising a second brake on the main shaft.

4. The transmission of claim 1, further comprising a second brake on a rotational shaft of the sun gear connected to the rotational shaft of the first motor/generator.

5. The transmission of claim 1, further comprising at least two of:
first brake on the main shaft;
second brake on a rotational shaft of the second sun gear;
second clutch that is configured to couple or decouple two of the four rotational elements of the power splitter to lock or unlock the power splitter.

6. The transmission of claim 1, wherein the second motor/generator is rotatably installed on the main shaft,
wherein means for integrating/separating the main shaft and the output shaft is disposed between the main shaft and the output shaft,
wherein means for integrating/separating the second motor/generator and the main shaft is disposed between the second motor/generator and the main shaft.

7. The transmission of claim 1, further a first clutch configured to transmit or interrupt a power from the engine, wherein the first clutch is on the main shaft connecting the engine and the power splitter.

8. The transmission of claim 1, wherein the transmission operates in an EV1 mode,
wherein a first brake is on the main shaft,
wherein in an EV1 mode at least one of the first motor/generator and the second motor/generator is used as a power source and the first brake is engaged on the main shaft.

9. The transmission of claim 1, wherein under the condition of releasing the first clutch, EV2 mode is implemented or in addition to the EV2 mode, at least one of EV3, EV4, and EV5 modes is implemented,
wherein a first clutch is configured to transmit or disconnect power from the engine, wherein the first clutch is on the main shaft connecting the engine and the power splitter,
wherein a second clutch is configured to couple or decouple two of the four rotational elements of the power splitter to lock or unlock the power splitter,
wherein the first brake is on the main shaft,
wherein a second brake is on a rotational shaft of the second sun gear,
wherein a third brake is on the first ring gear,
wherein in the EV2 mode, the first clutch is released, at least one of the first motor/generator and the second motor/generator is used as a power source, and the second clutch engages,
wherein in the EV3 mode, the first clutch is released, at least one of the first motor/generator and the second motor/generator is used as a power source, and the second brake is engaged,
wherein in the EV4 mode, the first clutch is released, at least one of the first motor/generator and the second motor/generator is used as a power source, the first brake is engaged, and
wherein in the EV5 mode, the first clutch is released, at least one of the first motor/generator and the second motor/generator is used as a power source, the first brake is released, the second brake is released, the third brake is released, and the second clutch is released.

10. The transmission of claim 1, wherein a first clutch is configured to transmit or disconnect power from the engine, and the first clutch is on the main shaft connecting the engine and the power splitter, and wherein the transmission operates in an HV mode in which an output transmitted from the engine to the main shaft is used as a power source and the first clutch is engaged.

11. The transmission of claim 1, wherein the transmission operates in at least one of MV1, MV2, and MV3 modes,
wherein a first clutch is configured to transmit or disconnect power from the engine, wherein the first clutch is on the main shaft connecting the engine and the power splitter,
wherein a second clutch is configured to couple or decouple two of the four rotational elements of the power splitter to lock or unlock the power splitter,
wherein the first brake is on the main shaft,
wherein a second brake is on a rotational shaft of the second sun gear,
wherein a third brake is on the first ring gear,
wherein in the MV1 mode, an output transmitted from the engine to the main shaft is used as a power source, and the first clutch is engaged, the second clutch is released, the third brake is activated, and the second brake is released,
wherein in the MV2 mode, an output transmitted from the engine to the main shaft is used as a power source, and the first clutch is engaged, the second clutch is engaged, and the first, the second and the third brakes are released, and
wherein in the MV3 mode, an output transmitted from the engine to the main shaft is used as a power source, and the first clutch is engaged, the second clutch is released, the first and the third brakes are released, and the second brake is activated.

12. The transmission of claim 1, further comprising a second ring gear meshes with one of the planet gears of the dual planet gear which does not mesh with the first ring gears, and the fourth brake is on the second ring gear,
wherein the second ring gear is configured to idly rotates without being applied with any reaction force other than when the fourth brake is activated thereto.

13. The transmission of claim 12, further comprising:
planet gear having more than two gear on it;
ring gear meshing with the gear of the planet gear having more than two gears on it respectively;
sun gear meshing with the gears of the planet gear having more than two gear on it respectively;
additional brakes are configured to stop or release the ring gears and the sun gear,
wherein the transmission operates in further EV and MV modes using additional brakes.

14. The transmission of claim 1, wherein the power splitter further comprises:
a first idler between the first sun and planet gears; and
a second idler between the first sun and planet gears.

15. The transmission of claim 1, wherein the power splitter further comprises:
a speed reducer between the second sun gear and the second planet gear;
a further planetary gear meshing with the second sun gear;
a further ring gear integrally coupled to the carrier of the power splitter; and
a further sun gear integrally formed with an additional carrier and meshing with the second planet gear.
